(19) United States
(12) Patent Application Publication
(10) Pub. No.: US 2016/0218762 A1
(43) Pub. Date: Jul. 28, 2016

(54) WEARABLE DEVICE BASED DATA PROCESSING PLATFORM APPARATUSES, METHODS AND SYSTEMS

(71) Applicant: NEPTUNE COMPUTER INC., Montreal (CA)

(72) Inventors: Simon Tian, Brossard (CA); Bin Tian, Brossard (CA)

(21) Appl. No.: 14/915,415

(22) PCT Filed: Aug. 28, 2014
(86) PCT No.: PCT/CN2014/085389

§ 371 Date: Feb. 29, 2016

(30) Foreign Application Priority Data
Aug. 28, 2013 (CN) 201310381557.X
Sep. 2, 2013 (CN) 201310390017.8

(51) Int. Cl. H04B 1/3827; H04M 1/02

(52) U.S. Cl. CPC H04B 1/385; H04M 1/0256; H04M 1/0274; H04B 2001/3861

(57) ABSTRACT

A band apparatus comprising a portable communication device and an embedded planar antenna is presented. The band apparatus comprises means to release the portable communication device from the band so it can be used independently. Moreover, the band apparatus also comprises means to connect the portable communication device to a planar antenna embedded in Cone of the band straps to significantly enhance the communication device wireless transceiving performance.

This application is a non-provisional of and claims priority under Patent Cooperation Treaty to: Chinese patent application No. 201310381557.X filed on Aug. 28, 2013 and Chinese patent application No. 201310390017.8 filed on Feb. 9, 2013.

The entire contents of the aforementioned application(s) are expressly incorporated by reference herein.

This application may contain material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### BACKGROUND

Technological advances on personal communication equipment have paved the road to the design and implementation of ubiquitous devices. Some ubiquitous devices are portable such as a Smartphone device. Such portable Smartphone devices deliver high-quality user experiences including personal communication, entertainment, and Internet capability. A user can conveniently carry a Smartphone device for his or her daily use.

### SUMMARY

The WEARABLE DEVICE BASED DATA PROCESSING PLATFORM APPARATUSES, METHODS, AND SYSTEMS disclosed herein provide a portable device that miniaturizes the physical dimensions of communication devices for example, mobile telephone technologies and to provide the means to carry personal miniaturized communication devices as a wearable technology. In some embodiments, a wristband allows a user to wear a communication device as a wrist-worn mobile communication device. In some embodiments, the communication device can be mounted on the wristband by aligning a connector slot positioned on the mobile communication device with a set of connector pins comprised by the wristband and applying an external force. In some embodiments, the wristband comprises a release button which can be pushed downwards to release a communication device mounted on the wristband.

In some embodiments, the wristband comprises an embedded planar antenna which can be physically and functionally coupled to the communication device while the communication device is mounted on the wristband to enhance the transceiving performance of the communication device. In some embodiments the planar antenna is implemented on a flexible substrate which can provide the antenna with an effective amount of flexibility to be embedded on the wristband straps such that the straps can be adjusted to tighten or loosen their engagement with the user's wrist.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates an example frontal view of a portable communication mobile device, according to one embodiment of the present invention.

FIGS. 2A-C illustrates example side views of the portable communication mobile device shown in FIG. 1, according to one embodiment of the present invention.

FIGS. 3A-D illustrates an example wristband carrier: receptacle and restraining and releasing mechanisms for a portable communication mobile device shown in FIG. 1, according to one embodiment of the present invention.

FIG. 4 illustrates an example back view of the portable communication mobile device shown in FIG. 1, according to one embodiment of the present invention.

FIG. 5 illustrates example user interface(s) (UI) showing user engagement options of a portable communication mobile device, according to one embodiment of the present invention.

FIG. 6 illustrates an example of internal components and interconnections of a portable communication mobile device shown in FIG. 1, according to one embodiment of the present invention.

FIG. 7 illustrates an example pairing between the portable communication mobile device and a touch screen device, according to one embodiment of the present invention.

FIG. 8 illustrates an example schematic diagram of a wrist carried communication mobile device, according to one embodiment of the present invention.

FIG. 9 illustrates an example schematic diagram showing a decomposition of a wrist carried portable communication mobile device, according to one embodiment of the present invention.

FIG. 10 illustrates an example schematic diagram showing a further decomposition of a wrist carried portable communication mobile device, according to one embodiment of the present invention.

FIG. 11 illustrates an example schematic diagram featuring a portable communication device wristband restraining mechanism and a partial view of the wristband receptacle, according to one embodiment of the present invention.

FIG. 12 illustrates an example schematic diagram featuring a portable communication device wristband release mechanism and a partial view of the wristband receptacle, according to one embodiment of the present invention

FIG. 13 illustrates an example schematic diagram featuring a portable communication device physically and functionally coupled to a flexible planar antenna, according to one embodiment of the present invention.

The features and advantages of the present invention will become more apparent from the detailed description set forth below when taken in conjunction with the drawings.

### DETAILED DESCRIPTION

Following below are more detailed descriptions of various concepts related to, and embodiments of, inventive systems, methods and apparatus for carrying a miniaturized communication device as a wearable item. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

### INTRODUCTION

Various embodiments of the present invention are directed generally to methods and apparatus for carrying a portable communication device as a wearable item. In some exemplary embodiments the wearable device is comprised by a portable communication device attached to a strap so it can be tightened with a strap adjuster around a user's wrist. In some embodiments, the wristband comprises a receptacle which can be employed to mount a portable communication device. Such a receptacle comprises a mechanism to restrain and release the portable communication device allowing the portable communication device to operate when it is mounted or un-mounted from the wristband.

In some embodiments one of the wristband's straps comprises an embedded planar antenna which can be physically and functionally coupled to the communication device while the communication device is mounted on the wristband to enhance the transceiving performance of the communication device. In some embodiments the planar antenna is implemented on a flexible substrate which can provide the antenna with an effective amount of flexibility to be embedded on the wristband straps such that the straps can be adjusted to tighten or loosen their engagement with the user's wrist.

In some instances, a communication device is comprised to make communication mobile devices wearable. In some embodiments, the portable communication device can comprise a mobile phone enabled with a subscriber identity module (SIM) card e.g., a micro-SIM card, voice calls, text messages and/or 2G, 3G and 4G technologies and the like functionalities. In some embodiments, the portable communication device can comprise a plurality of sensors including but not limited to accelerometers, gyroscopes, digital compasses, pedometers and/or the like sensors. In some embodiments, the portable communication device can comprise blue tooth, Wi-Fi and/or the like communication transceivers. In some embodiments, the portable communication device can comprise a thin-film-transistor liquid crystal display with touch-screen capabilities and/or the like displays. In some embodiments, the portable communication device can comprise a front and rear facing camera and a LED flash. In some embodiments, the portable communication device can comprise speakers, a microphone, a headphone jack and/or vibration alert. In some embodiments, the portable communication device can comprise random access and mass storage memory and/or the like memory chips.

Example Embodiments of a Portable Communication Device

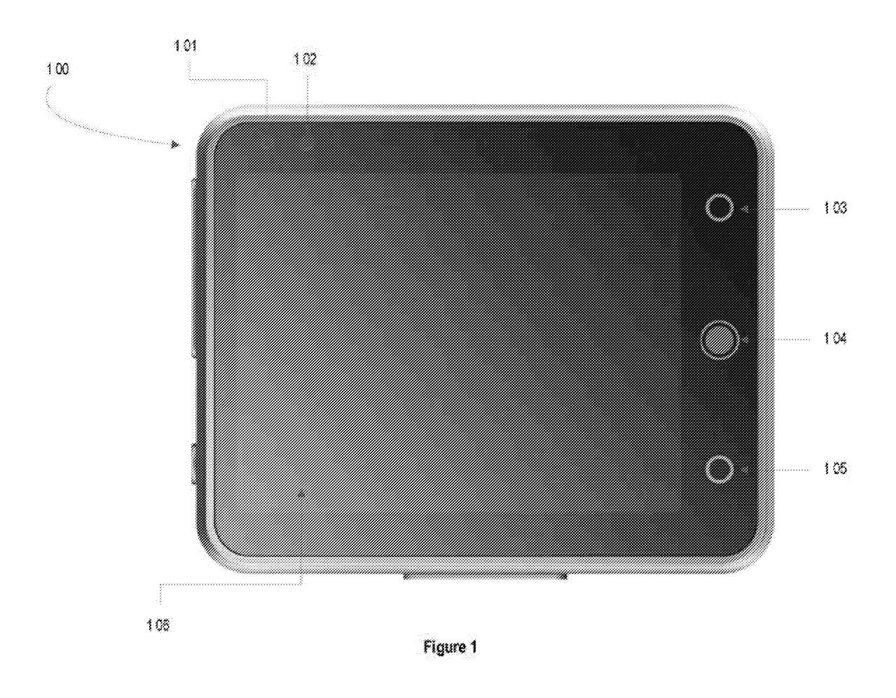

FIG. 1 illustrates an example frontal view of a portable communication mobile device, according to one embodiment of the present invention. The portable communication device 100 can comprise a LED flash 101 and a VGA camera 102. In some embodiments, the portable communication device can comprise a plurality of buttons which help a user to navigate through the variety of interfaces available in the device. For example, pressing button 103 causes the main menu or the current interface's menu to appear on the display, pressing button 104 causes the home page or home interface to appear on the display, and pressing the back button 105 enables the user to navigate to the previous web page or user interface. In some embodiments, the portable communication device can comprise a thin-film-transistor liquid crystal display (LCD) 106 with touch-screen capabilities and/or the like displays. In some embodiments, a plurality of electrical components comprised by the communication device, including but not limited to mobile phone components, sensor components, transceiver components, interface components, audio components, memory components and the like, are managed by a central processing unit, for example, a Qualcomm Snapdragon S4 1.2 Ghz Dual Core microprocessor and the like off the shelf and/or customized microprocessors.

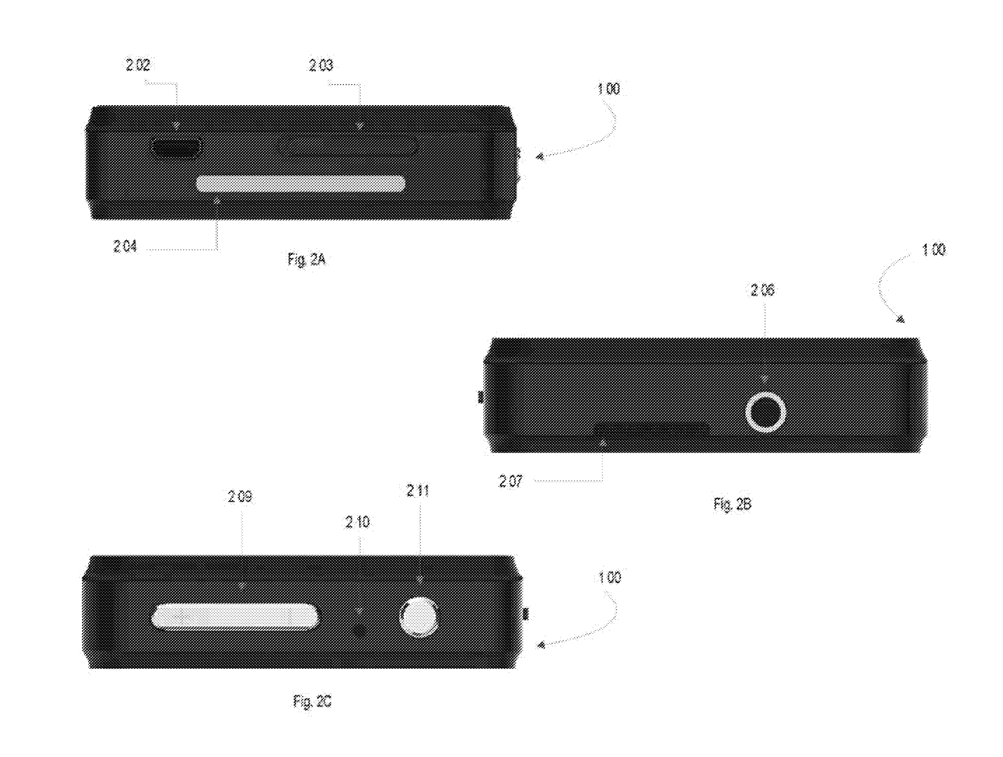

FIGS. 2A-C illustrates example side views of the portable communication mobile device, according to one embodiment of the present invention. In some embodiments FIG. 2A, the portable communication device 100 can comprise a micro USB port 202. In some embodiments, the portable communication device 100 can comprise a slot to insert a Micro-SIM card 203. In some embodiments, the portable communication 100 device can comprise a connector slot 204 to connect the device to other electronic devices, charge the device by connecting to a power source and/or connect the device to an antenna to enhance its communication performance.

In some embodiments FIG. 2B, the portable communication device 100 can comprise a headphone jack 206, and a speaker 207 to provide the user with sound feedback, voice communication and/or entertainment. In some embodiments FIG. 2C, the portable communication device can comprise a microphone 210, a power button 211, and a bar button to adjust the device's sound volume 209.

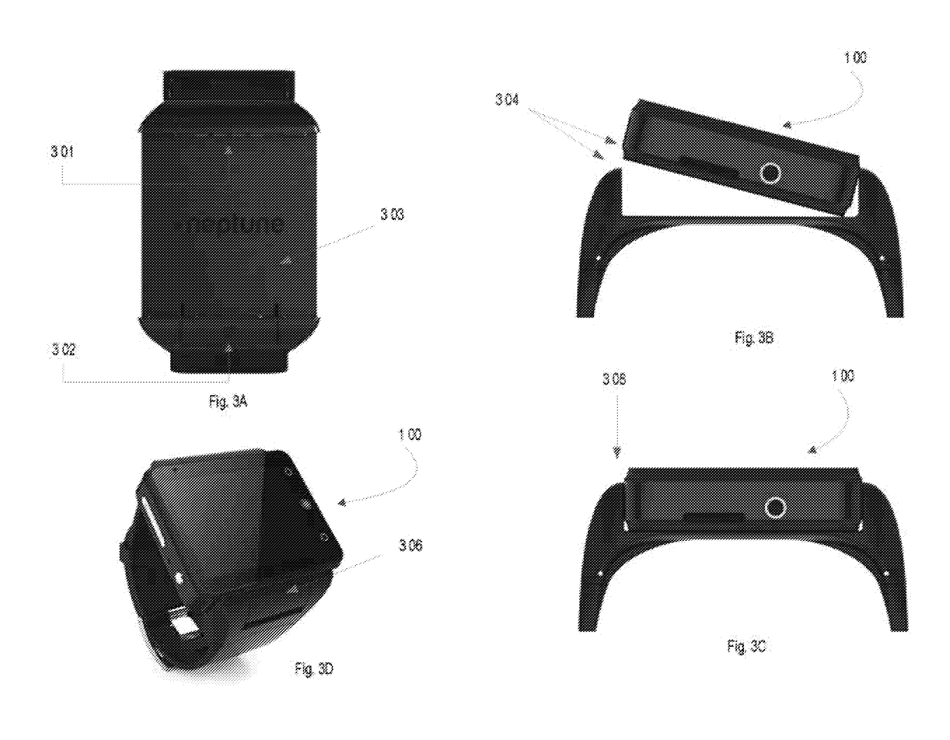

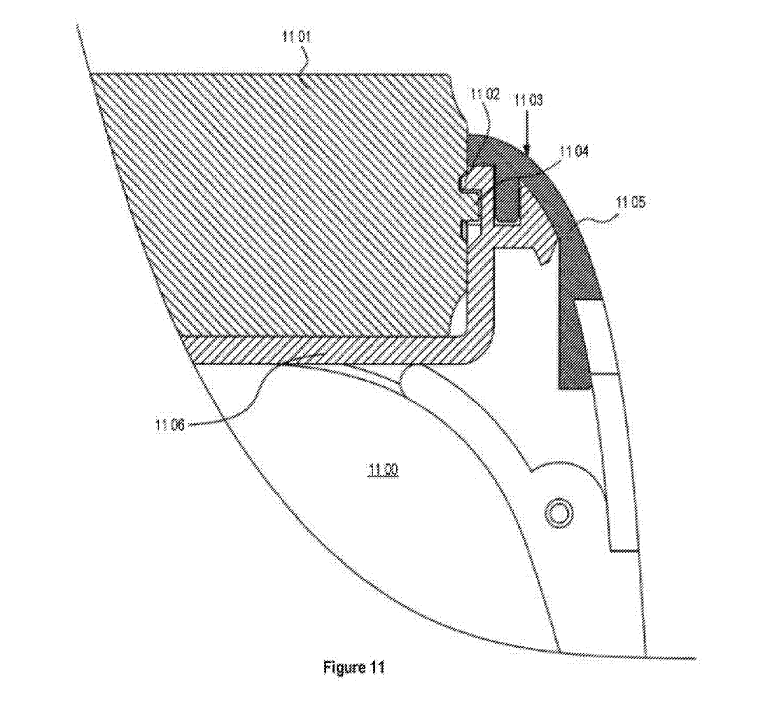

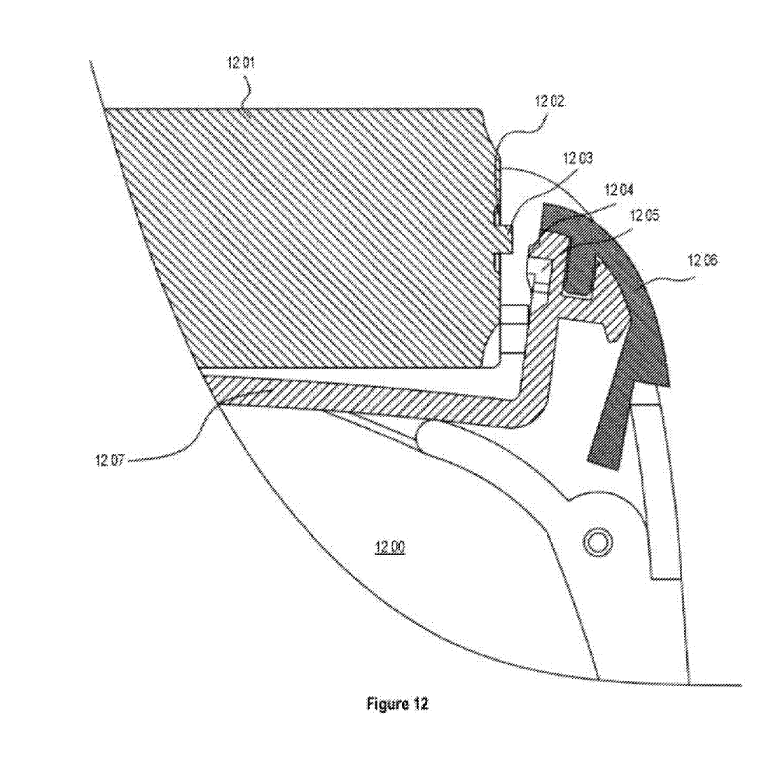

FIGS. 3A-C illustrates an example wristband carrier: receptacle and restraining and releasing mechanisms for a portable communication mobile device, according to one embodiment of the present invention. In some embodiments the portable communication device can be mounted on a wristband FIG. 3A. In some embodiments, such a wristband can comprise a receptacle 303 with a release button 302, and a plurality of conductive pins 301 to physically and functionally couple the portable communication device with a plurality of electrical elements that can be embedded in the wristband. In some embodiments FIG. 3B, the portable communication device 100 can be mounted on the wristband by aligning the device with the receptacle's arms 304 and applying an external force. In some embodiments FIG. 3C, the portable communication device 100 can be restrained by the receptacle's arms 308 preventing it to be detached from the wristband. In some embodiments FIG. 3D, the portable communication device 100 can be released from the wristband by applying an external force to a release button 306. Further examples of the restraining and releasing mechanism to mount the communication device on the wristband are provided in FIG. 11 and FIG. 12 of the present application.

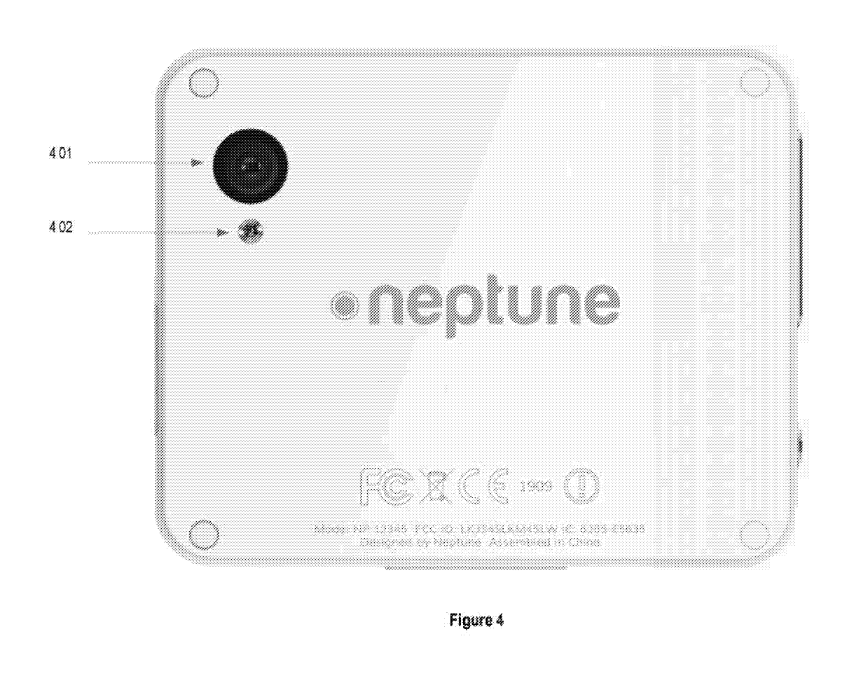

FIG. 4 illustrates an example back view of the portable communication mobile device, according to one embodiment of the present invention. In some embodiments, the portable communication device can comprise a rear-facing camera 401 and a rear LED flash 402 physically and electrically coupled to a central processing unit and which can be controlled via a camera graphical user interface accessible to a user through the communication mobile device display and/or touchscreen

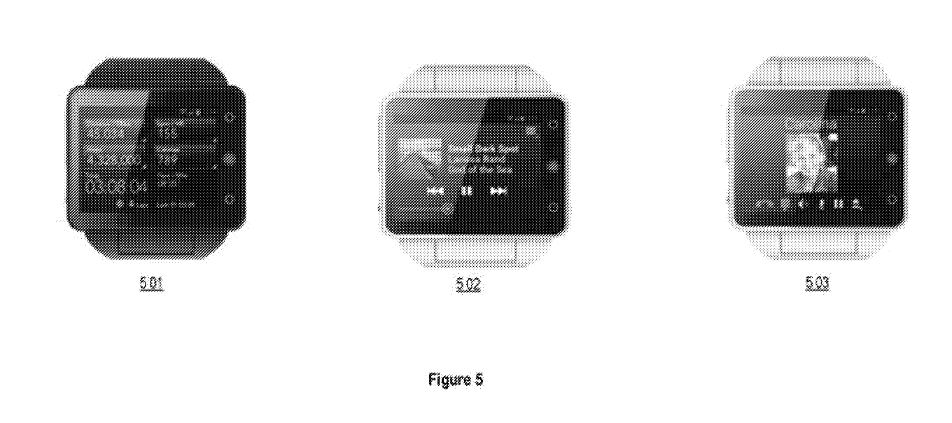

FIG. 5 illustrates example user interface(s) (UI) showing user engagement options of a portable communication mobile device, according to one embodiment of the present invention. In some embodiments, the portable communication device can provide a user with a plurality of engagement options. In some embodiments, the portable communication device can serve as a fitness lab keeping track of several fitness metrics 501. In some embodiments, the portable communication device can be employed to as an audio player 502. In some embodiments, the portable communication device can be employed to establish video calls to another party 503. A person having an ordinary skill in the art will be able to recognize that the presented interfaces are just a small sample of many potential interfaces that can be implemented in the portable communication device other possible interfaces include but are not limited to clock/watch, timer, calendar, temperature display, and/or the like interfaces.

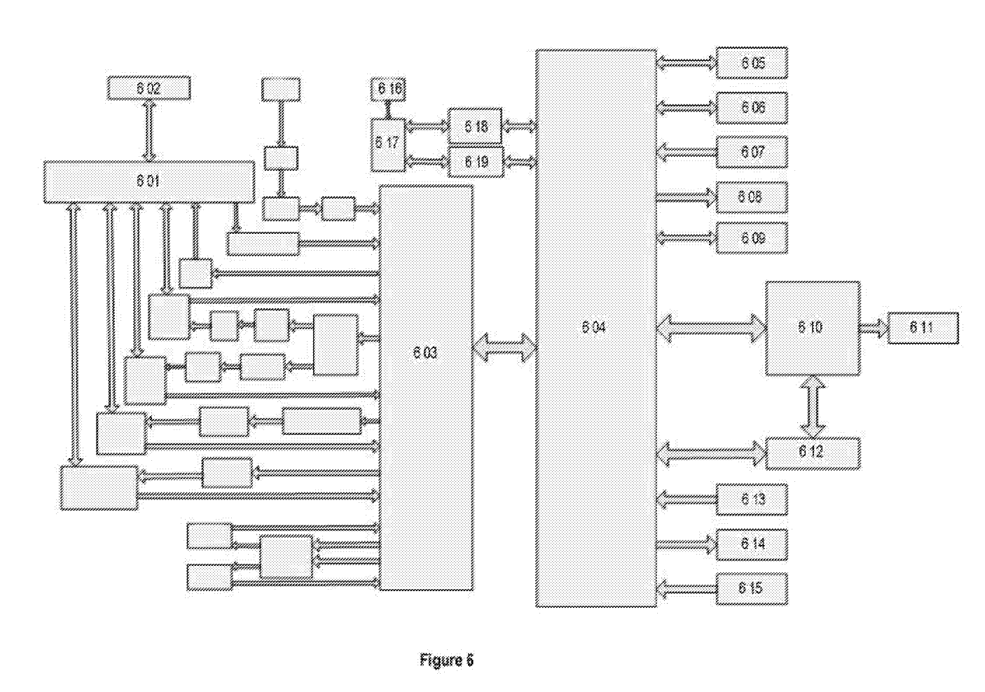

FIG. 6 illustrates an example of internal components and interconnections of a portable communication mobile device, according to one embodiment of the present invention. In some embodiments a central processor unit 604 can control and/or manage a plurality of electronic components. For example, the central processor unit 604 may include a Qualcomm Snapdragon S4 1.2 Ghz Dual Core microprocessor, and the like off the shelf and/or customized microprocessors. In some embodiments, the central processing unit 604 and other electronic components can be powered by a power source chip 610 such a power chip can be a PM8029 Power IC and/or the like power source electronic components. In some embodiments, the power source chip 610 can also be in direct connection with a speaker 611 and a micro Universal Serial Bus (USB) 612. In some embodiments, the central processor unit 604 can be connected to other electronic components including but not limited to a media player with T Card (e.g., RM-2501H) 605, a SIM card 606, a camera 607, a Liquid Crystal Display (LCD)/touchscreen display 608, a plurality of sensors 609, a microphone 613, a side key 614 and/or the like, to enable or disable the portable communication mobile device, and/or earphones 615 and the like electronic components.

In some embodiments, the central processor unit 604 can be in direct connection with a plurality of transceivers including but not limited to a Wi-Fi transceiver 618 e.g., AR 005G, a Bluetooth transceiver 619, e.g., WCN2243 and/or the like transceivers. In some embodiments, the transceivers may be in direct connection with a Front End Module (FEM) 617 integrating a plurality of components to establish radio-frequency based communications. In some embodiments, the FEM module 617 can be additionally connected to a Global Position System (GPS) antenna 616. In some embodiments, the portable communication mobile device can comprise a mobile phone transceiver 603 for example a RTR6285A. It may be clear to a person of the ordinary skill in the art that some embodiments may comprise many more additional electronic components for example a switch 601, to share resources between a plurality of components, for example a main communication antenna 602, memory chips, radio-frequency switches duplexers and/or the like electronic components.

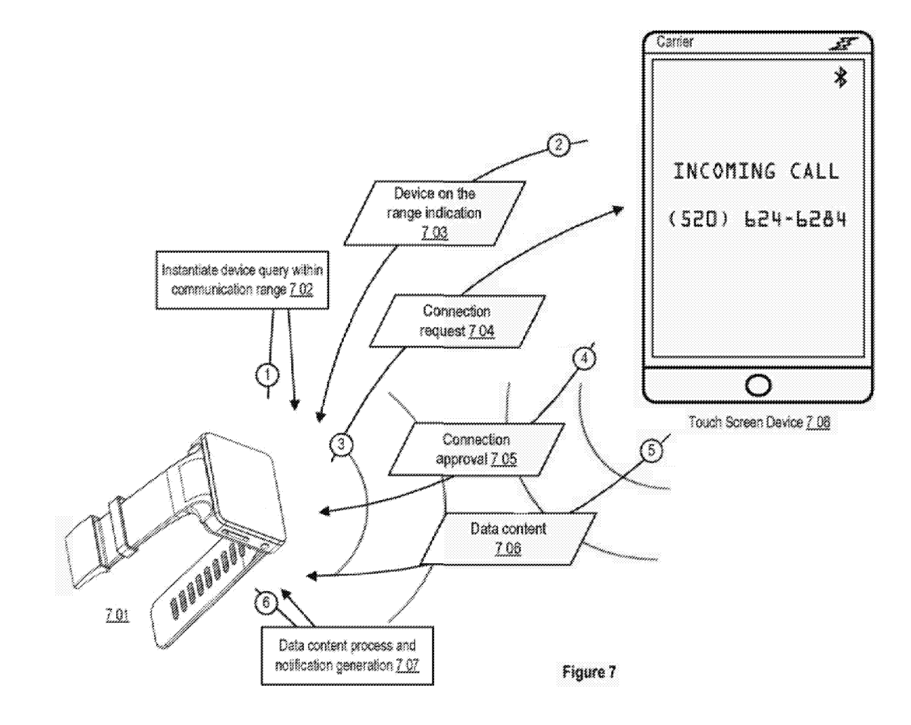

FIG. 7 illustrates an example pairing between a portable communication mobile device and a touch screen device, according to one embodiment of the present invention. In some embodiments, a portable communication device 701 can be paired with other devices such as a touch screen device 708 for the purpose of engaging the communication devices 708 as an enlarged display, and/or a control panel. For example, the touch screen device 708 can include a Smart device such as a Smartphone, a tablet computer, a laptop computer, and/or the like. As another example, the touch screen device 708 can include a touch screen display as an I/O device without a smart processor. In some embodiments, a portable communication device can instantiate a device query within communication range 702 to determine if a communication devices is located nearby. Thereafter, in some embodiments, the portable communication device can receive a device on range indication 703 from the touch screen 708. In some embodiments, the portable communication device can continue the pairing process by sending a connection request 704 to the already identified touch screen device 708. Then, in some embodiments, the portable communication device can receive a connection approval 705 from the already identified touch screen device 708. In an alternative implementation, the user may be prompted to enter a unique PIN number via the touch screen device 708 to establish connection for the first time with the portable device 701.

In some embodiments the touch screen device 708 can send data content 706 to the portable communication device 701, and the portable communication device can further process the receive data content and notify the user of the received data 707. In some embodiments, the portable communication device 701 can send data content to the touch screen device 708, such that the data is displayed for a user view and/or interaction. Example of data content that can be transceiver through the portable communication device to and from other electronic devices include but are not limited to text messages, electronic files image, text, video and/or audio and the like data content. In some embodiments, the portable communication device 701 can be similarly paired to other electrical devices different from the smart phone 708, for example intelligent thermostats, televisions, bending machine and/or any other device equipped with a transceiver required to establish a communication.

Example Embodiments of a Wristband for a Communication Device

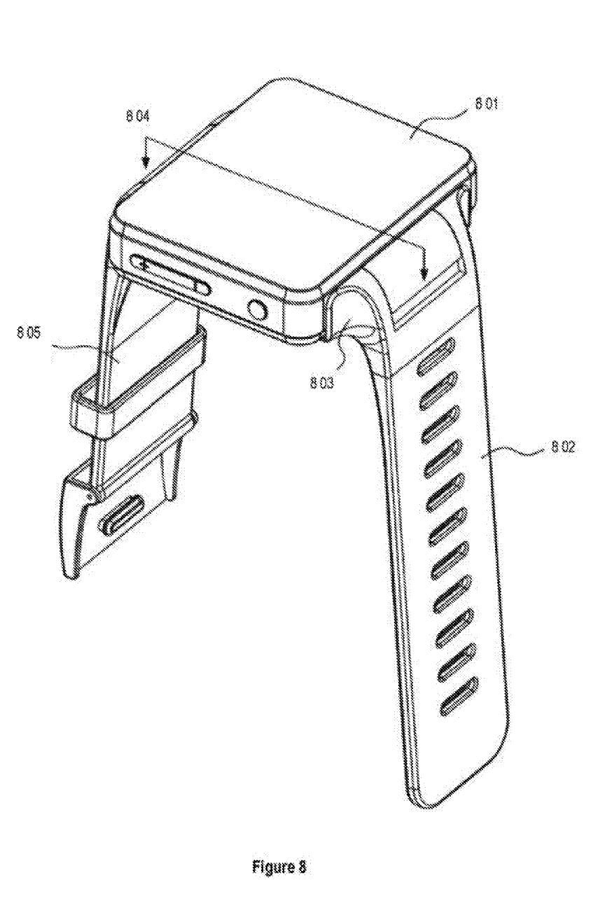

FIG. 8 illustrates an example schematic diagram of a wrist carried communication mobile device, according to one embodiment of the present invention. In some embodiments the wristband can comprise two straps 802 and 805 made of a flexible material such that the straps can be adjusted to tighten or loosen their engagement with the user's wrist. Examples of such a flexible material include but are not limited to leather, faux leather, nylon webbing, ceramic, silicone rubber and/or plastic. In some embodiments, the writs-band can have a receptacle 803 comprising two arms originated on the receptacle's base and extending perpendicularly to the base on opposite edges of the receptacle 804, which are capable to retain a portable communication device in a fixed position 801.

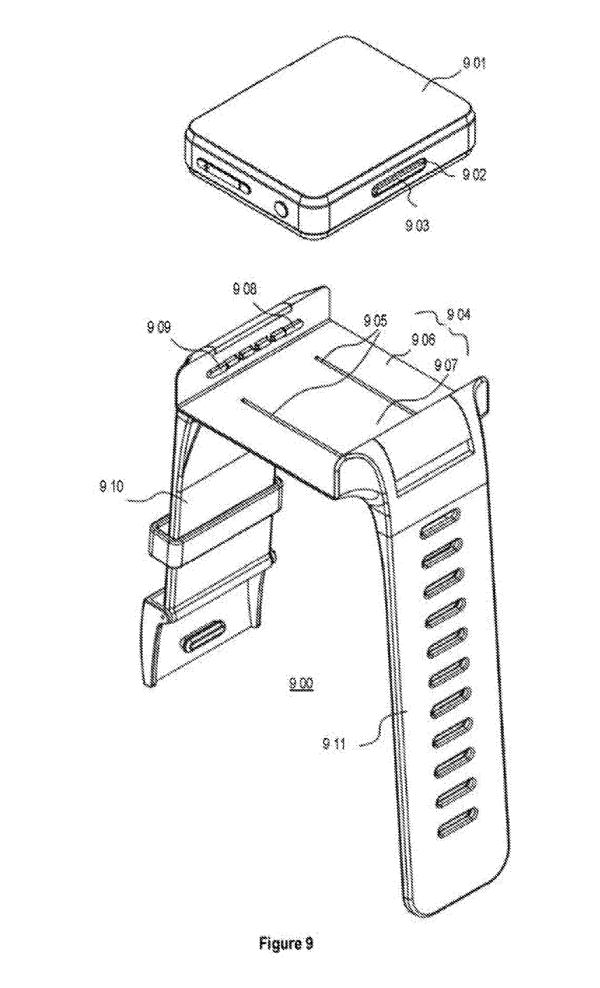

FIG. 9 illustrates an example schematic diagram showing a decomposition of a wrist carried portable communication mobile device, according to one embodiment of the present invention. In some embodiments, the portable communication device 901 can be mounted on the wristband 900 by aligning it with the writ-band's receptacle an applying an external force. Thereafter, the portable communication device can be used as a wearable device utilizing the straps 910 and 911 to adjust the wristband on a user's wrist. In some embodiments the receptacle comprises two arms originated on the receptacle's base 904 divided by one or more long narrow curs, openings or slits 905. In some embodiments, the receptacle can comprise a fixed arm 906 and a bendable arm 907 which is bendable with respect to the fixed arm 906. In some embodiments, the extent to which the bendable arm 907 can bend with respect to the fixed arm 906 depends on the length of the slits 905, that is, the longer the slits' length are, the greater the amount of flexibility of the bendable arm 907. In some embodiments, the receptacle can also comprise a plurality of metallic or magnetic conductive pins 908 and 909 which connect to a complementary part comprised in the portable communication device 901. In some embodiments, the conductive pins 908 and 909 can provide a conductive connection between the portable communication device 901 and the wristband 900. Similarly the receptacle comprises a counterpart groove or inward indentation (not shown in this figure) that is complementary to the shape 902 and connector or ledge 903 which in this embodiment projects outwards from the mounting plane (or side) of the portable communication device 901.

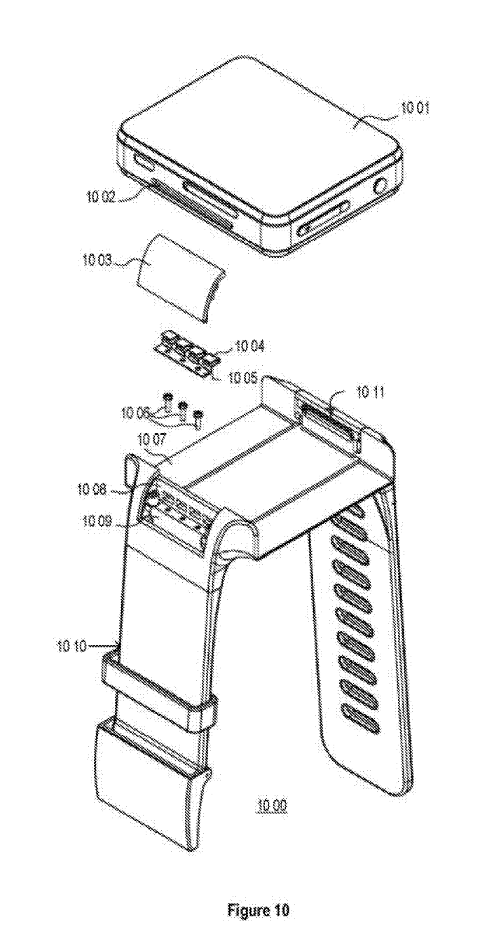

FIG. 10 illustrates an example schematic diagram showing a further decomposition of a wrist carried portable communication mobile device, according to one embodiment of the present invention. In some embodiments, the wristband 1000 can comprise a strap 1010, comprising a planar antenna mounting cavity e.g. 1008. In some embodiments, such as mounting cavity can comprise a fixed conductive portion 1009, which can be physically, connected to a body of a planar antenna embedded in the strap 1010. In some embodiments, a plurality of conductive pins 1004, can be secured to the fixed portion 1009, with a set of screws 1006 passing through the engagement surface 1005 and therefore extending the connectivity of the planar antenna to the conductive pins 1004. The antenna mounting cavity and screws can be covered with a customized lid 1003. As explained in previous figures, in some embodiments, a portable communication device 1001 can be mounted on the receptacle 1007. In some embodiments, the portable communication device can have a connector 1002 wherein the pins 1004 can be inserted to be physically and functionally coupled to the embedded planar antenna with the portable communication device 1001. In some embodiments, the receptacle comprise a groove or inward indentation wherein a counterpart connector or ledge pointing outwards from a side of the device 1001 can be inserted to restrain the device in a fixed position on the wristband

FIG. 11 illustrates an example schematic diagram featuring a portable communication device wristband restraining mechanism and a partial view of the wristband receptacle, according to one embodiment of the present invention. In some embodiments, a portable communication device 1101 can be mounted on a wristband 1100. In some embodiments, the portable communication device can be restrained in a fixed position in direct contact with the receptacle base 1106 by locking the device to the receptacle, in part with a connector which projects outwards from a mounting plane on the miniaturize communication device 1104 which can be inserted into the connectors or ledge counterpart for example a groove or inward indentation 1102 located in the inner side of one of the receptacle's arms.

In some embodiments, the wristband can comprise a mechanism to release the portable communication device 1101 from the wristband. For example, the movable part 1103 can receive an external force at the area 1105 leading the receptacle's arm comprising the groove 1102 to bend outwards from the portable communication device 1101 and consequently unlocking the device and allowing the device to be detached from the wristband 1100.

FIG. 12 illustrates an example schematic diagram featuring a portable communication device wristband release mechanism and a partial view of the wristband receptacle, according to one embodiment of the present invention. In some embodiments, one of the receptacles arms can be bended 1204, to unlock the portable communication device 1201 from the wristband 1200. In some embodiments, an external force can be applied to the movable piece 1206 leading to bend the receptacle base 1207 and the receptacle groove 1205 outwards from the portable communication device 1201 disengaging the connector 1203 fixed on the plane 1202 of the miniaturize communication device 1201 from the receptacle groove 1205 and therefore letting the device to be released from the wristband 1200.

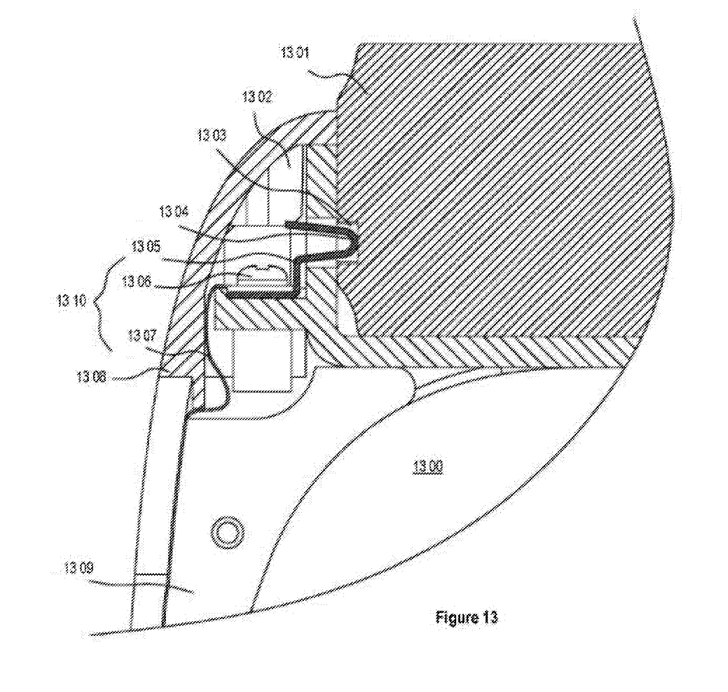

FIG. 13 illustrates an example schematic diagram featuring a portable communication device physically and functionally coupled to a flexible planar antenna, according to one embodiment of the present invention. In some embodiments, the portable communication device 1301 mounted on a wristband 1300 can be physically and functionally coupled to a planar antenna 1307 embedded in one of the wristband's straps 1309. In some embodiments, the planar antenna 1307 can extend along the length of the strap 1309. In some embodiments the planar antenna is implemented on a flexible substrate, which can provide the antenna with an effective amount of flexibility to be embedded on the wristband straps such that the straps can be adjusted to tighten or loosen their engagement with a user's wrist. In some embodiments, the flexible substrate wherein the planar antenna is implemented can be a polymer based dielectric material for example silicone elastomers such as Polydimethylsiloxane (PDMS) and/or PDMS-ceramic components. In some embodiments, the connection between the planar antenna 1307 and the portable mobile device 1301 can be attain through a series of conductive pins 1304 connected to a slot in the body of the portable communication device 1303. In some embodiments, the series of conductive pins can be fixed to the wristbands body through an engagement surface 1305 attached by one or more screws 1306 to the wristband. In some embodiments, the planar antenna extension 1310 can bridge the physical gap between the detachable portable communication device 1301 and the fixed planar antenna 1307. In some embodiments, the elements comprised by the antenna extension 1310, are housed in the planar antenna mounting cavity 1302 and can be covered by a customized lid 1308.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments of the invention can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single computer or distributed among multiple computers.

In this respect, various aspects of the invention may be embodied at least in part as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium or non-transitory medium) encoded with one or more programs that, when executed on one or more computers or other processors, perform methods that implement the various embodiments of the technology discussed above. The computer readable medium or media can be transportable, such that the program or programs stored thereon can be loaded onto one or more different computers or other processors to implement various aspects of the present technology as discussed above.

The terms “program” or “software” are used herein in a generic sense to refer to any type of computer code or set of computer-executable instructions that can be employed to program a computer or other processor to implement various aspects of the present technology as discussed above. Additionally, it should be appreciated that according to one aspect of this embodiment, one or more computer programs that when executed perform methods of the present technology need not reside on a single computer or processor, but may be distributed in a modular fashion amongst a number of different computers or processors to implement various aspects of the present technology.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A band apparatus comprising:
a receptacle having at least one slit to hold a portable personal device;
a portable personal device with at least one outwardly projected ledge for securing the portable personal device on the receptacle;
at least one strap mechanically connected to the receptacle to secure the portable device to a user's wrist; and
a release button connected to the receptacle to release the portable personal device from the receptacle.

2. The band apparatus of claim 1 wherein the portable personal device includes any of a touch screen display, a camera, and a speaker phone.

3. The band apparatus of claim 1, wherein the at least two slits divide the receptacle's base into at least two arms and at least one of the arms is in direct contact with the release button.

4. The band apparatus of claim 3, wherein an applied force to the release button causes the at least one arm in direct contact with the release button to bend with respect to the second arm.

5. The band apparatus of claim 4, wherein the at least one arm in direct contact with the release button causes the portable personal device to be detached from the receptacle.

6. The band apparatus of claim 1, wherein the portable personal device comprises a transceiver for receiving signals and/or transmitting signals.

7. The band apparatus of claim 6, wherein the at least one strap comprises a planar antenna.

8. The band apparatus of claim 7, wherein the planar antenna comprises a substrate flexible enough to allow the antenna to bend as the band strap is tightened and/or loosened around a human wrist.

9. The band apparatus of claim 8, wherein the receptacle further comprises an antenna extension with a plurality of conductive pins electrically connected to the planar antenna.

10. The band apparatus of claim 9, wherein the plurality of conductive pins are connected to the transceiver comprised by the portable personal device physically and functionally coupling the planar antenna with the portable personal device.

11. The wristband apparatus of claim 10, wherein the portable personal device is configured to be physically and functionally decoupled from the planar antenna by applying a force to the release button.

12. The band apparatus of claim 10, wherein the portable personal device is configured to establish a communicative connection with an electronic device via the planar antenna.

13. The band apparatus of claim 12, wherein content data is exchanged between the portable personal device and the electronic device.

14. The band apparatus of claim 13, wherein the content data includes any of text files, image files, audio files, and video files.

15. The band apparatus of claim 14, wherein the second device includes a touch screen display to communicate and receive information from a user.

16. A method comprising:
aligning a personal portable device ledge with a receptacle's arm, wherein the receptacle's arm comprises an inward indentation to secure the ledge;
inserting the aligned personal portable device into the receptacle, wherein the ledge is received by the inward indentation, so as to engage the personal portable device in a fixed position relative to the receptacle;
connecting the personal portable device to a flexible planar antenna, wherein the antenna is embedded in a band's strap mechanically connected to a receptacle; and
establishing a communicative connection with an electronic device via the planar antenna.

17. A method of claim 16, further comprising exchanging content data between the portable personal device and the electronic device, wherein the content data includes any of text files, image files, audio files, and video files.

18. The method of claim 16, further comprising:
applying a force to a mechanical release button, wherein the mechanical release button is physically connected to a bendable receptacle's arm;
bending, via the release button, the bendable receptacle's arm with respect to a fixed receptacle's arm, wherein the bendable receptacle's arm releases the personal portable device's ledge from the inward indentation; and
disconnecting the personal portable device from the flexible planar antenna; and
detaching the personal portable device from the receptacle.

19. A band apparatus comprising:
means for aligning a personal portable device ledge with a receptacle's arm, wherein the receptacle's arm comprises an inward indentation to receive the ledge so as to engage the personal portable device in a fixed position relative to the receptacle;
means for connecting the personal portable device to a flexible planar antenna, wherein the antenna is embedded in a band's strap mechanically connected to a receptacle; and
means for establishing a communicative connection with an electronic device via the planar antenna.

20. The apparatus of claim 19, further comprising means for exchanging content data between the portable personal device and the electronic device, wherein the content data includes any of text files, image files, audio files, and video files.
